(19) United States
(12) Patent Application Publication
(10) Pub. No.: US 2005/0069677 A1
(43) Pub. Date: Mar. 31, 2005

(54) Resistance element and method of manufacture

(76) Inventor: Richard E. Riley, Riverside, CA (US)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 10/950,030

(22) Filed: Sep. 24, 2004

Related U.S. Application Data
(62) Division of application No. 10/081,123, filed on Feb. 21, 2002, now Pat. No. 6,815,039.

(51) Int. Cl. B32B 1/00

(52) U.S. Cl. 428/141

(57) ABSTRACT

Conductive plastic resistance element having particles of conductive material embedded therein and projecting therefrom for reducing variations in contact resistance in a potentiometric device in which the element is employed. The element is made by processing carbon powder, resin, solvent and conductive phases to form a paste, applying the paste to a substrate, and curing the paste to drive off the solvent and form a film, with the conductive phases rising to the surface of the film and becoming embedded therein.

This application is a divisional of and claims the benefit of priority to U.S. patent application Ser. No. 10/081,123 filed on 21 Feb. 2002 and now U.S. Pat. No. 10/081,123, entitled Resistive Element For Potentiometric Devices and Method of Manufacture, which application is hereby incorporated by reference.

This invention pertains generally to variable resistors and, more particularly, to a conductive plastic resistance element for use in potentiometric devices, and to a method of manufacturing the same.

In potentiometers and other types of variable resistors, the rubbing action between the so-called wiper contacts and the resistive elements can change the topography or surface contour of the resistive elements over the lifetime of the devices. Such changes produce variations in resistance between the contacts and the resistive elements, and those variations can result in disturbances and erroneous readings in sensors and other instruments in which the potentiometers are utilized.

With conductive plastic resistance elements, there is relatively little wear on the elements, but there is a slight smoothing or polishing in the areas which are contacted by the wipers. This removes surface protrusions and decreases effective contact pressure, resulting in increased electrical resistance or noise between the resistance element and the wiper contact. In addition, a thin film of insulating material may form on the surface of the element due to the presence of lubricants and plastic material in the element.

Heretofore, the most widely used technique for reducing contact resistance variations with conductive plastic resistance elements has been to increase the contact pressure and to use a silicone lubricant between the wiper and the resistance element.

With other types of resistive elements, variations in contact resistance have been reduced by embedding particles of conductive material in the surface of the resistive element which is engaged by the wiper contact. U.S. Pat. Nos. 4,278,725 and 4,824,694, for example, show the use of conductive particles in cermet resistive elements, i.e. elements containing a mixture of ceramic and metallic materials. Such techniques have not, however, heretofore been employed in conductive plastic resistance elements.

It is in general an object of the invention to provide a new and improved resistance element for use in potentiometric devices, and to a method of manufacturing the same.

Another object of the invention is to provide a resistance element and method of the above character which overcome the limitations and disadvantages of conductive plastic resistance elements of the prior art.

These and other objects are achieved in accordance with the invention by providing a conductive plastic resistance element having particles of conductive material embedded therein and projecting therefrom for contact by the wiper of a potentiometric device in which the resistance element is employed. The resistance element is made by processing carbon powder, resin, solvent and conductive phases to form a paste, applying the paste to a substrate, and curing the paste to drive off the solvent and form a film, with the conductive phases rising to the surface of the film and becoming embedded therein.

A conductive plastic resistance element is made by combining carbon powder with a resin and solvent mixture, along with other fillers, wetting agents, and other components. These materials are mixed in a high shear mixer to form a viscous paste which is then screen printed onto a substrate and cured at temperatures on the order of 200° C. The curing operation drives off the solvents and crosslinks the plastic matrix to form a hard, abrasion resistant film. Carbon is the current carrying phase, and a higher percentage of carbon produces a cured film of lower resistance.

It has been found that electrical noise or variations in contact resistance can be significantly reduced by including conductive phases in the carbon/plastic matrix. One presently preferred conductor for this purpose is silver, particularly a deagglomerated spherical silver powder having a particle size of about 6.0 μm or less.

This silver is preferred because it has smooth, generally round particles that will not absorb excessive amounts of solvent in the mixture for the conductive plastic resistor material. In addition, the round shape promotes good electrical contact without excessively lowering the resistance value of the material. This is in contrast to flaked materials which tend to join together in a matrix of such materials and lower the resistance value significantly. The silver has a further advantage in that it is less costly than other materials such as palladium, gold or platinum.

It is believed that other metals such as palladium, gold, platinum and copper can be used in place of or in addition to silver. It is also believed that other metals and other conductive materials such as highly conductive forms of carbon can also be used. As noted above, however, silver is the preferred material because the silver particles enhance the conductivity between the wiper and the resistive element without degrading the wear properties of the element or producing major changes in its resistance value.

Another example of a material which has been used with good results is a mixture of silver and palladium in the form of a high purity, spherical, deagglomerated coprecipated powder containing about 70 percent silver and 30 percent palladium. Such a powder is available from Degussa Corporation, South Plainfield, N.J., under the product code K7030-10. This powder has properties similar to silver in reducing contact resistance variation, but it does have an effect on the resistance and a minor effect on the wear properties of the resistive element.

The amount and shape of the conductive phases is dependent to some extent on the contact resistance desired and on the type of contact used in the potentiometric device, and it is generally preferable that the amount of conductive material not be so great as to produce undesired changes in the electrical and mechanical properties of the resistance element. It has been found that the addition of about 10 to 20 percent silver or other metal (by weight) will significantly reduce the variation in contact resistance or surface conductivity without degrading the wear properties and overall resistance of the conductive plastic material. However, it is believed that useful range of added conductive phases extends from about 2 percent to about 50 percent (by weight).

In one presently preferred embodiment, the resistance element is manufactured by processing carbon powder, resin, solvent and conductive phases in a high shear mixer to form a paste, screen printing the paste onto a substrate, curing the paste at a temperature on the order of 200° C. to drive off the solvent and form a film, with the conductive phases rising to the surface of the film and becoming embedded therein.

### EXAMPLE

20 grams of a deagglomerated spherical silver powder having a particle size of about 6.0 μm or less were mixed with 80 grams of resistor ink comprising a suspension of carbon, boron nitride, and polytetrafluoroethylene powders in a solution of phenol resin in a mixture of butyl carbitol acetate and butyl carbitol.

The mixture was processed on a 3 roll mill using 150 pounds of roller pressure and two passes to thoroughly distribute the silver particles in the mixture. This ink was then printed onto a substrate and cured at a temperature of 200° C. for two hours.

The resistive element was tested and compared with another element made from the same ink without the silver particles. After 750,000 strokes with a wiper, the element with the silver particles had a contact resistance variation of only 1000 ohms, as compared with 6000 ohms for the element without the silver. Similar results were obtained after a 1.5 million strokes.

It is apparent from the foregoing that a new and improved conductive plastic resistance element and method of manufacture have been provided. While only certain presently preferred embodiments have been described in detail, as will be apparent to those familiar with the art, certain changes and modifications can be made without departing from the scope of the invention as defined by the following claims.

1. A resistance element comprising:
a carbon and plastic resistive matrix formed as a layer;
said carbon being a current carrying phase of said resistive matrix wherein a higher percentage of carbon relative to the percentage of plastic in said resistive matrix produces a lower resistance, and a lower percentage of carbon relative to the percentage of plastic in said resistive matrix produces a higher resistance; and
particles of conductive material are embedded in a surface of said layer and are exposed and project from said surface, said particles of conductive material forming a conductive phase at said surface operative to reduce a contact resistance at said surface and being present in an amount within a volume of said layer so that resistive properties of said resistive matrix are maintained.

2. The resistance element of claim 1, wherein the conductive material comprise deagglomerated metallic silver.

3. The resistance element of claim 1, wherein the conductive material comprises silver and palladiumdeagglomerated metallic powder containing about 70 percent silver and 30 percent palladium that does not tend to join together to form conductive metallic paths at said surface or through portions of said resistive matrix.

4. The resistance element of claim 1, wherein the conductive material is selected from the group consisting of silver, palladium, gold, platinum, copper, highly conductive carbon, and combinations thereof; and said conductive material is in the form of a deagglomerated metallic powder.

5. The resistance element of claim 1, wherein the conductive material is present in an amount equal to about 10 to 20 percent by weight of the resistive element.

6. The resistance element of claim 1, wherein the conductive material is present in an amount equal to about 2 to 50 percent by weight of the resistive element.

7. The resistance element of claim 1, wherein the particles of conductive material are no larger than about 6 microns and are formed in situ.

8. The resistance element of claim 1, wherein the conductive phases consist of silver.

9. The resistance element of claim 1, wherein the conductive phases consist of silver and palladium.

10. The resistance element of claim 1, wherein the conductive phases are selected from the group consisting of silver, palladium, gold, platinum, copper, highly conductive carbon, and combinations thereof.

11. The resistance element of claim 1, wherein the conductive phases are present in an amount equal to about 10 to 20 percent by weight of the resistive element.

12. The resistance element of claim 1, wherein the conductive phases are present in an amount equal to about 2 to 50 percent by weight of the resistive element.

13. The resistance element of claim 1, wherein the resistive element further includes a substrate and wherein the layer is disposed on said substrate.

14. The resistance element of claim 1, further including a wiper contact which engages said surface of said resistance element.

15. The resistance element of claim 1, wherein:
the conductive material is selected from the group consisting of silver, palladium, gold, platinum, copper, highly conductive carbon, and combinations thereof; the conductive material is present in an amount equal to about 2 to 50 percent by weight of the resistive element; and
the conductive material is in the form of a deagglomerated metallic powder.

16. The resistance element of claim 15, wherein the deagglomerated metallic powder is in the form of particles that are no larger than about 6 microns;

17. The resistance element of claim 16, wherein the resistive element further includes a substrate and wherein the layer is disposed on said substrate.

18. The resistance element of claim 17, further including a wiper contact which engages said surface of said resistance element on said substrate.

19. A method of manufacturing a resistance element, comprising:
processing carbon powder, resin, solvent and conductive phases to form a paste, applying the paste to a substrate, and curing the paste in situ to drive off the solvent and form a film, with the conductive phases rising to the surface of the film and becoming embedded therein.

20. The method of claim 19, wherein the paste is cured at a temperature on the order of 200° C.

21. The method of claim 19, wherein the paste is screen printed onto the substrate.

22. The method of claim 19, wherein the carbon powder, resin, solvent and conductive phases are processed in a high shear mixer.

23. The method of claim 19, wherein:
the film includes a carbon and plastic resistive matrix that is disposed as a layer, said carbon being a current carrying phase of said resistive matrix wherein a higher percentage of carbon relative to the percentage of plastic in said resistive matrix produces a lower resistance, and a lower percentage of carbon relative to the percentage of plastic in said resistive matrix produces a higher resistance; and
the conductive phase includes particles of conductive material that are embedded in a surface of said layer and are exposed and project from said surface, said particles of conductive material forming a conductive phase at said surface operative to reduce a contact resistance at said surface and being present in an amount within a volume of said layer so that resistive properties-of said resistive matrix are maintained.

24. The method of claim 19, wherein the particles of conductive material are no larger than about 6 microns.

25. The method of claim 19, wherein the conductive material includes deagglomerated smooth generally round metallic silver powder that does not tend to join together in the resistive matrix.

26. The method of claim 19, wherein the conductive material includes silver and palladium deagglomerated spherical metallic powder containing about 70 percent silver and about 30 percent palladium that does not tend to join together in the resistive matrix.

27. The method of claim 19, wherein the conductive phases consist of silver.

28. The method of claim 19, wherein the conductive phases consist of silver and palladium.

29. The method of claim 19, wherein the conductive phases are selected from the group consisting of silver, palladium, gold, platinum, copper, highly conductive carbon, and combinations thereof.

30. The method of claim 19, wherein the conductive phases are present in an amount equal to about 10 to 20 percent by weight of the resistive element.

31. The method of claim 19, wherein the conductive phases are present in an amount equal to about 2 to 50 percent by weight of the resistive element.

32. A method of making a resistance element comprising:
disposing a carbon and plastic resistive matrix as a layer on a substrate, said carbon being a current carrying phase of said resistive matrix wherein a higher percentage of carbon relative to the percentage of plastic in said resistive matrix produces a lower resistance, and a lower percentage of carbon relative to the percentage of plastic in said resistive matrix produces a higher resistance;
selecting the amount of said conductive material within a volume of said layer so that resistive properties of said resistive matrix are maintained; and
embedding particles of said conductive material in a surface of said layer and are exposed and project from said surface, said particles of conductive material forming a conductive phase at said surface in situ during curing of said resistive matrix and operative to reduce a contact resistance at said surface.

33. The method in claim 30, further comprising:
processing carbon powder, resin, solvent and said conductive phases to form a paste, applying the paste to said substrate, and curing the paste in situ to drive off the solvent and form said layer as a film, with the conductive phases rising to the surface of said film and becoming embedded therein.

34. A potentiometric device comprising:
a resistive element; and
a wiper contact which engages a surface of said resistance element;
said resistive element comprising a carbon and plastic resistive matrix formed as a layer on a substrate;
said carbon being a current carrying phase of said resistive matrix wherein a higher percentage of carbon relative to the percentage of plastic in said resistive matrix produces a lower resistance, and a lower percentage of carbon relative to the percentage of plastic in said resistive matrix produces a higher resistance; and
particles of conductive material are embedded in said surface of said layer and are exposed and project from said surface, said particles of conductive material forming a conductive phase at said surface operative to reduce a contact resistance at said surface and being present in an amount within a volume of said layer so that resistive properties of said resistive matrix are maintained.
